(19) United States
(12) Patent Application Publication
(10) Pub. No.: US 2012/0046936 A1
(43) Pub. Date: Feb. 23, 2012

(54) System and method for distributed audience feedback on semantic analysis of media content

(75) Inventors: Kunal Kandekar, Jersey City, NJ (US); Alfredo C. Issa, Apex, NC (US); Richard J. Walsh, Raleigh, NC (US); Ravi Reddy Katpelly, Durham, NC (US)

(73) Assignee: Lemi Technology, LLC, Wilmington, DE (US)

(21) Appl. No.: 12/662,248

(22) Filed: Apr. 7, 2010

Related U.S. Application Data
(60) Provisional application No. 61/167,369, filed on Apr. 7, 2009.

(51) Int. Cl. G06F 17/27; G06Q 50/00; G06Q 99/00

(52) U.S. Cl. 704/9; 705/347; 704/E15.001

(57) ABSTRACT

A system and computer implemented method of distributed audience feedback of media content in real time or substantially real time, including: semantically analyzing, at a semantic speech analysis engine, media content from a media program and identifying relevant topic data; distributing, at a topic data publisher, the identified relevant topic data to an audience of the media program; collecting, at a server, audience opinions on the identified relevant topic data; and processing the collected audience opinions. Other embodiments are disclosed.

### CROSS REFERENCE TO RELATED APPLICATIONS

The present application claims priority from U.S. Provisional Application No. 61/167,369 filed on Apr. 7, 2009, the disclosure of which is incorporated herein by reference in its entirety.

### FIELD OF THE INVENTION

The present disclosure relates generally to a media system and, more particularly, to a system and method for distributed audience feedback based on semantic analysis of media content.

### BACKGROUND OF THE INVENTION

With the proliferation of live talk radio programs and television programs having audience participation of some form, allowing the audience at large to participate and interact with the host of the particular program at some point during the program has become a popular segment and is, no doubt, a factor in maintaining the desired ratings of such programs. Typically, audience members must call in and be individually screened and accepted to express their views and/or interact with the host. While online opinion polls are also used, they are not conducted in real time, the topics discussed are chosen by a human operator, and the results are published at a later time. While engaging in a real-time chat with the program host is also possible, this can be distracting to the host, requires moderation, and has other control issue problems.

Thus, it would be beneficial to provide listeners/viewers/audience members with additional tools to facilitate large scale participation with respect to live media programming.

### SUMMARY OF THE INVENTION

Systems and methods consistent with the present disclosure relate to facilitating large scale participation of listeners, viewers, and/or audience members with respect to live media programming.

Moreover, systems and methods consistent with the present disclosure enable the majority of an audience a way in which to influence media program or show content in real time.

Systems and methods consistent with the present disclosure also allow for the collecting of distributed audience opinions on topics that are identified by semantic analysis of the media program content.

According to one aspect, the present disclosure provides a computer implemented method of distributed audience feedback of media content in one of real time or substantially real time, including: semantically analyzing, at a semantic speech analysis engine, media content from a media program and identifying relevant topic data; distributing, at a topic data publisher, the identified relevant topic data to an audience of the media program; collecting, at a server, audience opinions on the identified relevant topic data; and processing the collected audience opinions.

In the method, the media content may be at least one of a video content, an audio content, a live talk radio show content, a live television talk show content, a live lecture content, or a live web-cast content.

According to another aspect of the present disclosure, a system is provided for distributed audience feedback of media content, including: means for semantically analyzing media content from a media program and identifying relevant topic data; means for distributing the identified relevant topic data to an audience of the media program; and a server which collects audience opinions on the identified relevant topic data, and which processes the collected audience opinions.

According to another aspect of the present disclosure, a system is provided for distributed audience feedback of media content, including: a semantic speech analysis engine which semantically analyzes media content from a media program and identifies relevant topic data; a topic data publisher which distributes the identified relevant topic data to an audience of the media program; and a server which collects audience opinions on the identified relevant topic data, and which processes the collected audience opinions.

The present disclosure also contemplates a non-transitory, computer readable medium including a program for instructing a media system to: semantically analyze media content from a media program and identify relevant topic data; distribute the identified relevant topic data to an audience of the media program; collect audience opinions on the identified relevant topic data; and process the collected audience opinions.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a system for distributed audience feedback including the flow of information and the various components in the context of a talk radio setting according to an exemplary embodiment of the present disclosure;

FIG. 2 depicts an example of a graphical user interface (GUI) for enabling an audience participant's feedback according to an illustrative embodiment;

FIG. 3 depicts an illustrative embodiment of a method operating in the system of FIGS. 1 and 2;

FIG. 4 illustrates a simplified block diagram of the exemplary embodiment depicted in FIG. 1;

FIGS. 5A and 5B illustrate a more detailed internal working of the blocks in FIG. 4;

FIG. 6 is a block diagram of a system hosting the distributed feedback service; and

FIG. 7 is a block diagram of a user device according to one embodiment of the present disclosure.

### DETAILED DESCRIPTION OF THE PREFERRED EMBODIMENTS

The embodiments set forth below represent the necessary information to enable those skilled in the art to practice the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

Note that at times the system of the present invention is described as performing a certain function. However, one of ordinary skill in the art would know that the program is what is performing the function rather than the entity of the system itself. Further, embodiments described in the present disclosure can be implemented in hardware, software, or a combination thereof.

Although aspects of one implementation of the present invention are depicted as being stored in memory, one skilled in the art will appreciate that all or part of systems and methods consistent with the present disclosure may be stored on or read from other non-transitory, computer-readable media, such as secondary storage devices, like hard disks, floppy disks, and CD-ROM, or other forms of a read-only memory (ROM) or random access memory (RAM) either currently known or later developed. Further, although specific components of the system have been described, one skilled in the art will appreciate that a system suitable for use with the methods and systems consistent with the present disclosure may contain additional or different components.

As indicated above, systems and methods consistent with the present disclosure allow for the collecting of distributed audience opinions on topics that are identified by semantic analysis of the media program or show content. As will be described in more detail below, the system performs semantic analysis of media program content, uses this analysis output to generate opinion polls, presents the opinion polls to the media program audience, gathers the results of the opinion polls, and provides results of the opinion polls as feedback to the media program host and the media program audience in near real time. While an exemplary embodiment is discussed below in the context of a talk radio show scenario, one skilled in the art will appreciate that a system suitable for use with the methods and systems consistent with the present disclosure may be employed in other media programming context such as, but not limited to, live television such as a television talk show, live web-casts, live lectures, audio/video in general, or the like.

A more detailed description of the systems and methods consistent with the present invention will now follow with reference to the accompanying drawings.

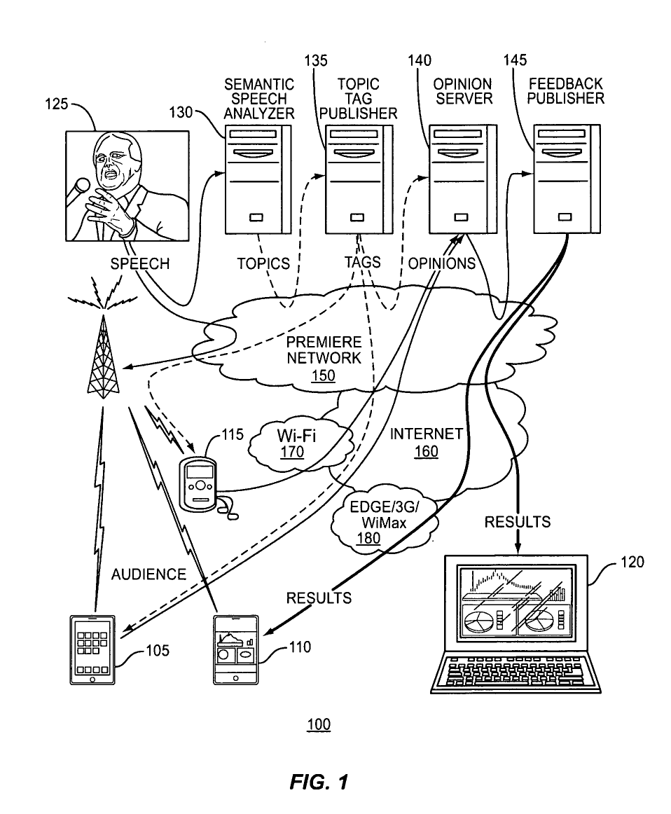

FIG. 1 illustrates a system for distributed audience feedback 100 including the flow of information and the various components in the context of a talk radio setting according to an exemplary embodiment. In FIG. 1, the dashed lines represent the flow of semantically identified topics and topic tags, the thin solid lines generally represent the flow of input from communication devices/media players 105, 110, 115, 120 (see also the input from the talk radio show host 125), and the thick dark lines denote the flow of results in the form of feedback to the media program host (e.g., talk radio show host 125) and the media program audience (e.g., talk radio listeners) in real time or substantially (near) real time. The communication devices used by the media program audience may be smart phones (see smart phones 105 and 110), laptop computers 120, personal computers, a digital audio player with Internet capability 115, or the like. One of the communication devices, such as but not limited to the laptop computer 120, may be used by the talk radio show host 125 to obtain audience/listener feedback as will be discussed in detail below.

In the system for distributed audience feedback 100, the speech of the talk radio show host 125 (denoted by the thin line and arrowhead labeled “Speech”) may be semantically analyzed via, for example, speech-to-text conversion followed by processing by a semantic speech analyzer or analysis engine 130 in order to identify relevant topic data. Thus, the semantic speech analyzer or analysis engine 130 serves as means for semantically analyzing media content from a media program and identifying relevant topic data. Of course, if transcripts of a portion or all of the media program are available, they can be used for analysis along with or in place of the speech-to-text conversion operation. Semantic analysis and natural language processing techniques known in the art may be applied to extract the context and content of, for example, the talk show monologues or dialogues, These techniques include techniques such as topic extraction to extract keywords or terms that identify the main topic or topics of the speech. Further, sentiment analysis or opinion extraction can be used to identify opinions of the speaker and other sources on the identified topics.

In one embodiment, the radio program may determine the list of topics from current events by automatically scanning a news aggregation service, such as Google News™, or monitoring a social aggregation service, such as Twitter. (For more information, please see U.S. patent application Ser. No. 12/326,670, filed Oct. 2, 2008, the disclosure of which is incorporated herein by reference in its entirety.) These topics may be compared with the topics extracted through semantic analysis to confirm their selection, or to rank them or to filter out any incorrectly identified topics. In one embodiment, topics comprising those extracted from speech, or the news aggregation service, or both, may be shown to the talk show host, and the show host may select one or more topics from the shown topics for publishing as a poll. In another embodiment, the topics can be determined by identifying the speaker, and extracting the history of topics that were identified for a previous similar show or by the same show host. The similarity information can be analyzed based on metadata information of the show such as show type, etc. Still further, topics that were identified for a similar show but by a different show host, may also be listed among the listed topics. The system may further analyze the relevance of topics during speech-to-text conversion and natural language processing based on, for example, a density or frequency of that topic in the audio content of the talk show, strength of the topics, speech metrics associated with the use of the topics or terms related to the topic in the audio content of the talk show. As an example, speech metrics may be a volume of a speaker's voice, which may be described as shouting, yelling, normal, or whispering. (For more information, please see U.S. patent application Ser. No. 12/273,709, filed Nov. 19, 2008, the disclosure of which is incorporated herein by reference in its entirety.)

The results of the semantic analysis, topic extraction and sentiment analysis can be further analyzed to generate or identify relevant topics, sub-topics and/or keywords by the semantic speech analyzer 130 by using ontology or taxonomy. The ontology or taxonomy may be created, modified, or limited by the content producers. Ontologies can be further used to discover related terms or keywords by traversing the ontological graph in a context-sensitive manner. An ontology may need to be queried with the terms or keywords to determine one or more nodes with a name or associated data that match. For example, the complete phrase “U.S. Energy Policy,” or variations such as “Energy Policy,” or “Energy” are used to perform a semantic query against the ontology. The results may potentially include “President Obama,” “Campaign 2008,” “Mideast Oil,” “Light Bulbs,” etc. The relevant topics may comprise keywords, tags, or other metadata describing a topic, or an identifier for a specific topic. Traversing in a context-sensitive manner may comprise, for example, traveling the ontology graph and only considering, or further exploring nodes that also have relationships to the identified topics. For instance, an exemplary identified topic may be “US Energy Policy”, and traversing the ontology from the node for “US Energy Policy” may lead to the node for “President Obama,” which may have a further link to a node for his pet dog, Bo. However, since Bo may not have expressed any opinion on the matter, his node in the ontology may not have a relationship to the node for “US Energy Policy”, and hence would not be a candidate for further exploration. Similarly, the President's node may have a relation to Vice President Biden's node, but since the Vice President may not have expressed a significantly differing opinion, his node in the ontology may have a relationship to the node for “US Energy Policy” but still would not be a valuable candidate for further exploration in the context of “US Energy Policy”. Traversing the ontology in this manner would help identify related topics, keywords or opinions on the identified topics, as well as provide an indication of the controversy or other interest level for those topics, which could be used to further guide the traversal to identify other potentially interesting topics or sub-topics. In an embodiment, configurable thresholds may be used to examine related nodes to a specified degree. For example, one or more thresholds could be set to explore two nodes deep around topics related to politics, but ignoring nodes related to energy drinks. Further, sentiment analysis could be used to identify topics of interest worth polling, for instance by assigning higher preference to topics that are controversial or on which people have expressed counter-views or alternate views. For instance, if the Resource Description Framework (RDF) specification is used to describe the ontology, identifying such topics would require searching for subjects whose predicates comprise relationships such as “controversy”, “counter”, “opposing” or “alternate”. The semantic speech analyzer 130 provides the generated or identified topics and/or keywords and, potentially, also the related sentiments to a topic data or tag publisher 135, as shown by the dashed line and arrowhead labeled “Topics.”

The generated relevant topics are distributed by the topic tag publisher 135 (see the dashed lines and arrowheads denoted “Tags” emanating from the topic tag publisher 135) to the media program audience/participants (in this example to the communication devices/media players 105, 110, 115, 120 of the media program audience/participants participating in the talk radio show) via multiple channels, and also provided to a data storage device such as a database included in, for example, an opinion server 140. Of course, the server may be a single unit or a plurality of servers or data processing units. Thus, the topic tag publisher 135 serves as means for distributing the identified relevant topic data to an audience of the media program. For example, the relevant topics and/or keywords may be published via any of multiple available channels, including but not limited to: Internet websites; broadcasting or multicasting the identified topic data in the same channel as the content by multiplexing; embedding into the content stream via piggybacking, watermarking, or other such techniques known in the art; broadcasting on a separate but related channel; broadcasting via existing infrastructure such as radio data system (RDS); publishing to third party applications on consuming devices or associated devices via unicast or multicast packets over the Internet, wide area network (WAN), local area network (LAN), or cellular networks; instant messaging (IM); short message service (SMS) messages; etc. FIG. 1 depicts examples of some of these channels operating together; namely, a radio syndication network (e.g., a Premiere Network) 150, the Internet 160, wireless fidelity (Wi-Fi) 170, and EDGE/3G/Worldwide interoperability for microwave access (WiMax) 180.

Using a user opinion function implemented in, or otherwise accessed by communication devices/media players (105, 110, 115, 120), the media program audience/participants view the topics on their respective communication devices/media players (105, 110, 115, 120) and express their opinion on those topics using, for example, the keypad to type their response, with the thin solid lines and arrowhead labeled “Opinions” representing the input from communication devices/media players back to the opinion server 140. The opinions can be votes, user generated messages, positive/negative slide bars, and so on. The opinions may follow generic, pre-configured templates, such as “Yes/No/Maybe” or “Cool/Not Cool/Don't Care”. The opinion data from the media program audience/participants is collected and aggregated by the opinion server 140.

Collecting the audience opinions may comprise presenting the identified topic data to an audience member/participant, generating (if necessary) and presenting semantically relevant options, receiving audience member/participant opinion on the identified topic data, and communicating the received audience member/participant opinion to the networked opinion server 140. The opinion server 140 semantically analyzes the audience member/participant opinion data, if necessary, and collects statistical data on the audience member/participant opinion data. For instance, in alternate embodiments, audience opinions may be accepted in the form of voice input from audience members calling in, and their opinions can be converted via speech-to-text, topic extraction, and sentiment analysis into votes matching the generic, pre-configured templates such as Yes/No/Maybe, etc. In yet another embodiment, these opinions may be received in the form of text submitted via web browsers or SMS messages. If any topics or opinions thus collected do not match an existing opinion or topic published by the topic tag publisher 135, they are assumed to be alternate topics or opinions suggested by the audience, and can be considered separately or along with those previously published. Thus, the opinion server 140 serves as means for collecting audience opinions on the identified relevant topic data, and as means for processing the collected audience opinions.

The opinion server 140 then sends the processed and analyzed opinion data as feedback results to the feedback publisher 145 which in turn makes the collected opinion data available (see the thick dark lines and arrowheads labeled “Results” emanating from the feedback publisher 145) in real time or near real time to the talk radio show host 125 via, for example, laptop 120, to the producers of the media program, and to the media program audience/participants via their respective communication devices/media players (105, 110, 115). Thus, the feedback publisher 145 serves as means for providing the processed opinion data as feedback results in real time or near real time to at least one of a media show host via a communication device, a producer of the media program via a communication device, or the media program audience participants via their respective communication devices. Similar to the topic channels, the feedback may be collected via any channels, including but not limited to: polls on Internet websites; reporting using applications on consuming devices or associated devices via unicast or multicast packets over the Internet, WAN, LAN, or cellular networks; IM; or SMS messages; etc. Again, exemplary channels are depicted in FIG. 1.

The media program host, such as the talk radio show host 125, and the media program audience/participants, can therefore observe/listen to the individual opinions as well as an overview of the various opinions of other audience/participants quickly, thus enabling the talk radio show host to respond to his/her audience's views in real time or in substantially (near) real time.

The distributing of the identified topic data to the media program audience/participants via their respective communication devices/media players, as well as the collecting of audience opinions on identified topics, may be carried out under access control, such that topic data and feedback participation are only provided to receivers who are verified to be actively consuming the media program. A system such as disclosed in Applicants' Provisional Application No. 61/167,366, filed on Apr. 7, 2009 and entitled “System and Method for Access Control Based on Streaming Content Consumption,” which is incorporated herein by reference in its entirety, may be used to ensure that only people actually listening/watching the media program are permitted to provide feedback.

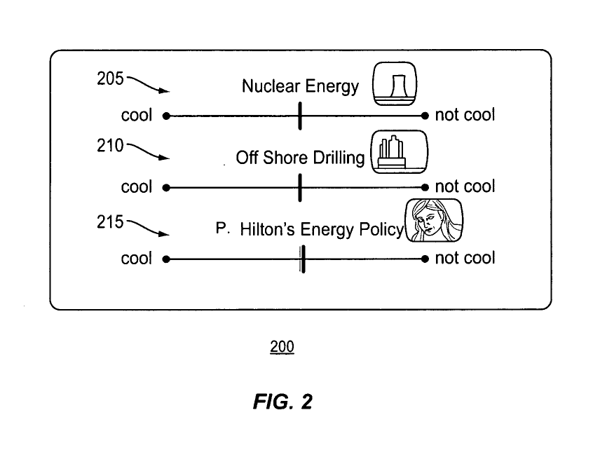

FIG. 2 depicts an example of a graphical user interface (GUI) 200 for enabling an audience participant to provide feedback according to an illustrative embodiment. For example, the audience participant's communication device/media player (105, 110, 115, 120) can present a GUI to the audience participant in the form of a series of slide bars to permit the audience participant to register his/her opinion as more or less cool for the identified topics, for example, nuclear energy 205, off-shore drilling 210, and P. Hilton's energy policy 215. Clearly, this is simply one example of a GUI that can be employed. In alternate embodiments, a text message may be generated presenting the topic and related feedback options, which may be displayed on the user device, or sent to the user's device via SMS. The message may include instructions to enable the audience to provide feedback. For instance, if audience opinion is solicited via SMS, the message may include instructions on how to vote using SMS using language such as “To vote for Nuclear Energy, text ‘YES NUKES’ to 555-1234. To vote against Nuclear Energy, text ‘NO NUKES’ to 555-1234.” As another example, if audience opinion is solicited via calling in, the message may include instructions such as “To express your opinion on the US Energy Policy, call 555-1234.” For client devices without displays, this text may be converted to speech and delivered via the audio output of the device.

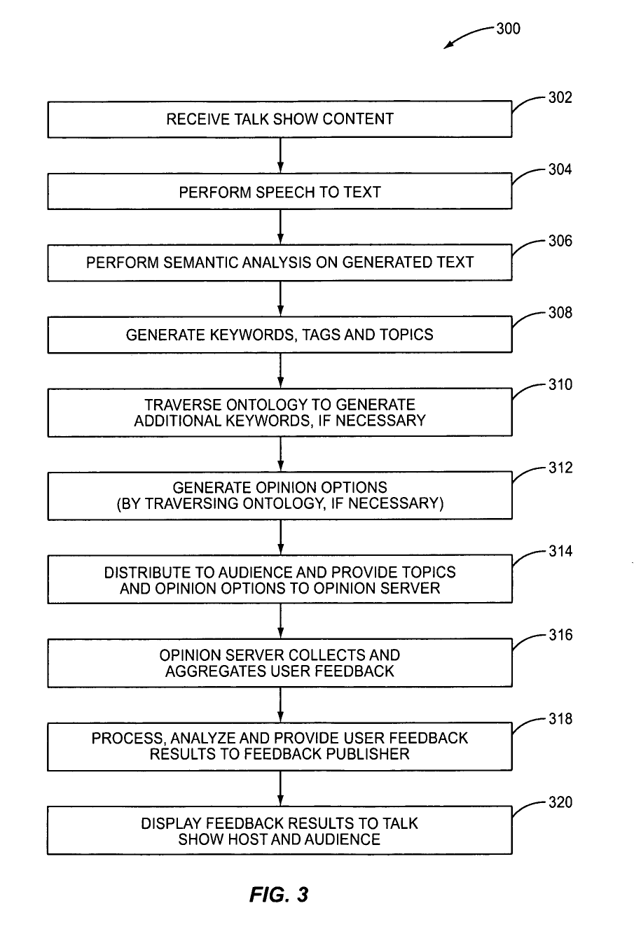

FIG. 3 depicts an illustrative embodiment of a method 300 operating in the system of FIGS. 1 and 2. It should be understood that more or less steps may be included. At step 302, the system first receives media program content, such as, e.g., talk radio show content, at the semantic speech analyzer 130. At step 304, the semantic speech analyzer 130 performs speech-to-text conversion, and semantically analyzes the generated text of the media program content at step 306. The semantic speech analyzer 130 further generates topics, tags, and/or keywords at step 308 by using ontology or taxonomy. The semantic speech analyzer 130 can further traverse the ontology to generate additional keywords, if necessary (see step 310), and generate opinion options by traversing ontology or sentiment analysis or a combination of both, if necessary (see step 312). The semantic speech analyzer 130 provides the generated or identified topics and/or keywords to the topic tag publisher 135, and the generated relevant topics are distributed by the topic tag publisher 135 to the media program audience/participants and to the opinion server 140 at step 314. The opinion data from the media program audience/participants is collected and aggregated by the opinion server 140 at step 316. In step 318, the opinion server 140 processes, analyzes, and then provides the feedback opinion data to the feedback publisher 145 which in turn makes the feedback opinion data available in real time or near real time to the talk radio show host 125 and to the media program audience/participants via their respective communication devices/media players (105, 110, 115, 120) in step 320.

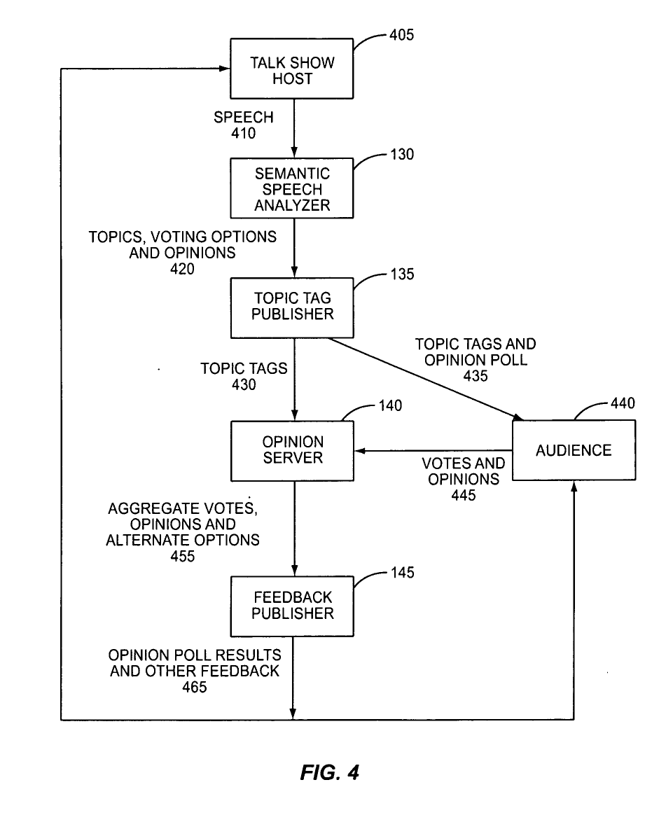

FIG. 4 illustrates a simplified block diagram of the exemplary embodiment depicted in FIG. 1. The Talk Show Host 405 provides speech input 410 to the Semantic Speech Analyzer 130 via an input means. The input means could be a microphone or any other multimedia input device. In one embodiment, it may be a network interface receiving speech, audio or multimedia content from a remote source. The Semantic Speech Analyzer 130 generates Topic and Opinion Keywords 420 and provides them to the Topic Tag Publisher 135. The Topic Tag Publisher 135 converts these keywords into an opinion poll 435, containing topic “tags” and opinion options and publishes them via one or more distribution channels to the user devices 105 through 120, which constitute the audience 440. The Topic Tag Publisher 135 also provides the topic tags 430 to the Opinion Server 140, using a potentially different format more suitable for further processing, The Opinion Server 140 also aggregates feedback 445 from the audience 440 as aggregated votes or other opinions or alternate topics 455. The Opinion Server 140 processes the aggregated data and provides the processed votes, opinions and alternate topics 455 to the Feedback Publisher 145. The Feedback Publisher 145 then publishes these results via one ore more distribution means, making them available to the audience 440 as well as the Talk Show Host 405.

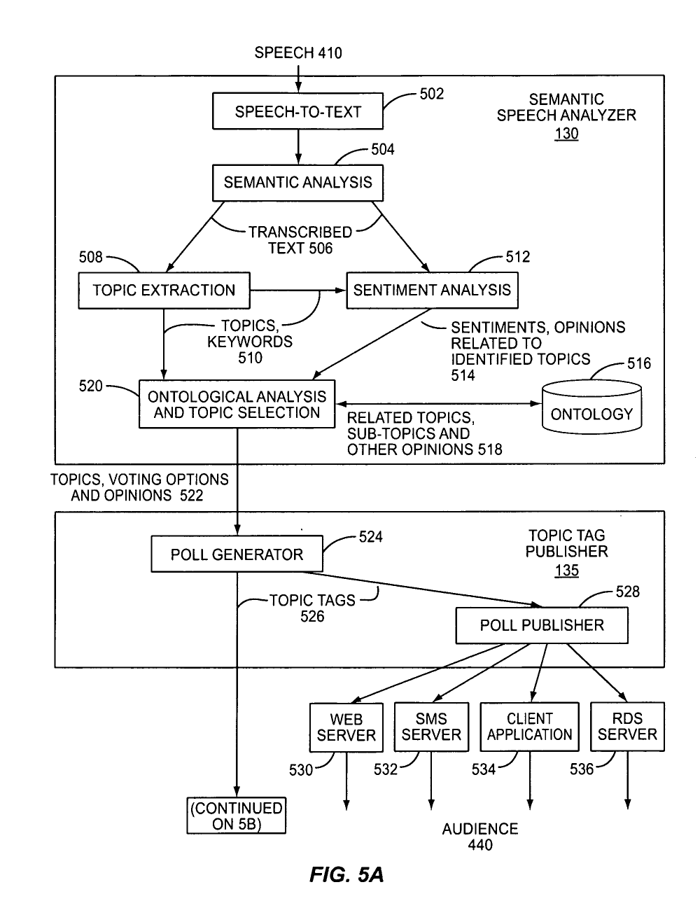

FIGS. 5A and 5B illustrate a more detailed internal working of the blocks in FIG. 4. The Semantic Speech Analyzer 130 comprises a speech-to-text function 502, which converts input speech or multimedia 410 into a text format. Further semantic analysis techniques known in the art may be performed by the semantic analysis function 504 to reduce errors and any ambiguities, and generate transcribed text 506. Note that if a text transcript is provided to the Semantic Speech Analyzer 130, these functions may be unnecessary. In one embodiment, the function 504 may generate an alternate representation of the textual content that is more appropriate for further processing by subsequent functions, for example using representations such as a First Order Predicate Calculus-based representation or the Resource Description Framework (RDF) specification. In an alternate embodiment, the subsequent functions accept the text transcript 506 as is, and may generate and use appropriate representations internally.

The transcribed text 506 is provided to the topic extraction function 508, which applies one or more Natural Language Processing techniques known in the art to identify relevant subject topics contained in the speech, for instance using statistical linguistic models and methods. Extracted topics may be represented as a set of one or more keywords 510. The extracted keywords 510 as well as the transcribed text 506 are provided to a sentiment analysis function 512, to identify the speaker's sentiments or opinions about the topics identified by the keywords 510. One or more of the sentiment analysis techniques known in the art may be used to extract the speaker's opinions 514. In one embodiment, very simple techniques such as identifying adjectives or adverbs and classifying them as positive (e.g., “good”, “excellent”, or “approve”) or negative (e.g., “bad”, “terrible”, or “disapprove”) may be sufficient to estimate whether the speaker has a positive or negative opinion about the topic. Alternatively, much more sophisticated methods may be applied to get a more accurate and detailed sentiment analysis, potentially at the cost of requiring much more computation. The resulting identified sentiments may be provided simply as keywords (e.g., “approve”/“disapprove”, “like”/“dislike”, or “good”/“bad”), or numeric values (e.g., positive values indicating approval or negative values indicating disapproval), or text snippets expressing the sentiment (e.g., “ . . . I think wind energy is safer than nuclear . . . ”), a structured representation indicating relative likes and dislikes (e.g., “wind energy=+5; nuclear energy=−1” indicates the speaker prefers wind energy to nuclear), or a combination of these.

The topic keywords 510 from topic extraction function 508 and speaker opinions 514 from sentiment analysis function 512 are provided to an ontological analysis and topic selection function 520. This function uses these topic keywords along with a pre-configured set of rules to traverse an ontology database 516 to identify relevant related topics, issues and sub-topics, as well as alternative topics and opinions 518. Techniques for intelligent, contextual or rule-based traversal of ontological databases to identify strongly related topics are well known in the art. For instance, a node for the topic “Energy Policy” may have a strong relation to the node for the topic “Energy”, which may in turn have links to nodes for “Oil”, “Nuclear Energy”, “Solar Energy”, “Coal Energy” and “Wind Energy”, which may contain properties (or, depending on the design of the ontology, may have further links to other nodes) describing their advantages, disadvantages, and public opinion about them. Thus, a single node “Energy Policy” can be expanded into multiple related topics “Oil”, “Nuclear”, “Solar” and so on, which can be used as voting options in a poll. This function also performs topic selection to identify the most relevant of the retrieved topics and opinions. This could be performed using multiple techniques and inputs. For example, the speaker's opinions extracted via sentiment analysis are used as an input, where the stronger a sentiment expressed on a topic, the more likely it would be published. Other inputs could include, for instance, currently popular topics, newly identified topics, and topics that have been appearing in recent news as reported by a news aggregator like Google News™ may be ranked higher, whereas topics that have recently been covered on the show, or those previously discarded by the talk show host may be ranked lower. Note that such context for a topic may also be contained in and provided by the ontology. Also note that all or some of the ranked topics may be displayed to the talk show host or talk show producer for further selection.

One or more of the topics and their related options and opinions that thus rank the highest are selected and provided as a set of keywords 522, representing topics, voting options, and opinions, to the Topic Tag Publisher 135. Note that the topic keywords and, potentially, the related topic and opinion keywords, may be provided as structured text, or in another data structure that expresses the relationship between each topic and the related options, using representation formats such as key-value pairs (e.g. “Topic=‘Energy’; Options=‘Oil, Nuclear, Solar, Coal, Wind’;” or “Topic=‘Nuclear Energy’; Opinions=‘Efficient, Unsafe, Polluting’;” etc.) or other structured text formats like XML or JSON.

In an embodiment, an ontology can be traversed and/or analyzed using a degree of randomness rather than by strictly following as set of rules. By doing so, less related, but potentially more interesting, topics may be determined. For example, preset rules, such as described in the immediately preceding paragraphs above, may require topic selection function 520 to follow links from one topic to the next, based on the strongest semantic relationships, and to traverse no more than, for example, three hops in any direction. Strength of a semantic relationship could again be determined by rules about the type of relationships. Introducing randomness could, for example, increase the limit on hops randomly, or randomly choosing a less relevant relationship. As an example, assume the words inside the square brackets indicate the relationship (or, predicate) between the topics, which are in quotes. An exemplary traversal may look like this:
“US Energy Policy” [is a type of] “Energy Policy”
“Energy Policy” [is about] “Energy Generation”
“Energy Generation” [can be of type] “Nuclear Energy”
“Energy Generation” [can be of type] “Oil”
“Energy Generation” [can be of type] “Wind Energy”etc.

In the above example, the distance from “US Energy Policy” to “Oil,” “Nuclear,” “Wind,” etc., is two deep. These relationships could go on indefinitely. Therefore, there is a need to restrict the depth exploration to preserve relevancy, as well as to maintain computational feasibility. This can be done by, for example, 1) restricting the distance to explore (e.g., traverse no more than three hops per link), and 2) choosing relevant links (e.g., choose only relationships “is about,” “is a type of,” “can be of type,” “consists of,” etc., or choose only links that lead to topics that contain related keywords). Thus, introducing randomness can mean allowing more distance to be traversed, and allowing a different kind of relationship (e.g., allowing relationship “has disadvantage” could lead to—“Nuclear Energy” [has disadvantage] “Safety Concerns”). A risk of choosing random links, or any other randomness, is that relevancy may deteriorate. Therefore, randomness may need to be balanced by further filtering. For example, there may be a link between “Nuclear Energy” and “Nuclear Weapons”, which may turn up through random exploration. However, the topic of “Nuclear Weapons” is irrelevant in the context of “US Energy Policy” (the originating topic), and would need to be filtered out.

In one embodiment, the audience may simply be presented a selected topic 522 and asked for their opinions, or whether they agree with the speaker's opinion on that topic, under the assumption they were listening when the speaker expressed an opinion on the topic. In more advanced embodiments, a poll could be generated by using the related topics, sub-topics and opinions to generate voting options for an opinion poll. The topic, option, and opinion keywords 522 are provided to a poll generator function 524 that converts these into “topic tags” 526, which comprise a simple format appropriate for distribution and/or audience polling. A topic tag may simply contain one or more topic keywords, the voting options and potentially also presentation instructions (e.g., simple “Yes”/“No” option or a sliding scale between “Agree” and “Disagree”) as well as voting instructions (e.g., “To vote, call this number . . . ” or “Let us know at http://www . . . com”). This conversion may involve simple rule-based text formatting and substitution, or conversion to visual display as depicted in FIG. 2. Note that, as mentioned above, in the absence of concrete or clearly identified voting options or opinions, generic options may be generated using pre-configured templates and published instead, such as “Agree with Host”/“Disagree with Host”.

The resulting topic tags 526 are provided to the poll publisher function 528. This function publishes the poll to the audience 440 via one or more distribution means, such as publishing on an affiliated website using a web server 530; or sending via SMS to subscribing users' cellular telephone devices 105 and 110 via an SMS server 532; or directly transmitting via unicast or multicast to a client application 534, which could be running on user devices 105, 110 and 120; or broadcasting as RDS data via an RDS server 536, to be received by a radio receiver device 115, for example, enabled to recognize and handle topic tags. The poll publisher function 528 may also customize the topic tag 526 contents differently for different distribution means, by, for example, adding specific voting instructions. For instance, when the poll is distributed via SMS, instructions to submit votes via SMS may be added, whereas if being distributed via a website, the topic tags 526 may be embedded in a dynamic HTML page allowing users to vote with a single click. These distribution means provide the opinion poll, potentially in the form of topic tags, to be presented to the audience by way of their devices 105 through 120.

Topic tags 526 are also provided from the poll generator 524 to the Opinion Server 140. The opinion poll manager function 537 receives these tags, and encapsulates each one separately into a data structure representing a published opinion poll 538. In addition to the information in the topic tag itself, this data structure may include additional contextual information, such as a unique ID, the date and time the poll was generated and published, any additional metadata or notes, such as those provided by the host or producer of the show, and so on. Note that the unique ID may be generated by the opinion poll manager function 537, or by poll generator function 524 or poll publisher function 528, for associating the ID with the published poll, which may then be associated with the opinions provided by audience members. Thus, the data structure of opinion poll 538 may be used to identify, track, and store the results of the poll, the popularity of the poll, as well as other auditing information. Note that this structure may be stored as a record in a database (not shown), which could be a relational database. Also note that multiple polls may be published simultaneously, and potentially different polls to different members of the audience, based on, for example, profile matching. In such cases, opinion poll manager 537 may help in maintaining and tracking multiple polls simultaneously.

The generated poll record 538 is provided to an opinion aggregator function 540, which receives opinions from members of the audience 440 via multiple means such as means 530, 532, 534, and 535. The opinion aggregator function associates received opinions with the appropriate published polls, for example by using the poll ID that user opinion submissions may include. The opinion aggregator 540 then separates received opinions for each poll based on its submission format, into for instance, spoken opinions 542 (which may be received, for example, via user call-in 535), text opinions 544, or explicit votes 546 for the presented options. Explicit votes 546 can include those that are generated by users simply selecting one of the presented options in a poll, and thus they would be received in a simple format and are straightforward to automatically tally. However, submissions in other formats would, of course, require additional processing.

The spoken opinions may be converted to text 550 by a speech-to-text function 548, which may be identical to the speech-to-text function 502. The transcribed text 550 and received text opinions 544 are provided to a spam filter function 552. The spam filter attempts to remove unwanted, irrelevant, or malicious submissions, for instance by monitoring for and removing submissions with expletives, or those submissions containing certain keywords such as “Viagra”, or repetitive or multiple submissions by the same user. In addition, any of the known techniques of spam filtering may be used as well. The filtered text submissions are provided to the semantic analysis, topic extraction and sentiment analysis function 556, which may be identical in operation to the functions 504, 512 and 520. Thus, the output of the function 556 may be similar in format to the topics, voting options and opinions 522 provided by function 520. Hence, the output of function 556 can be easily compared to the selected topics 522. Any topic in the output of function 556 that matches a topic in output 522 and/or the published topic tags 526 is assumed to be a vote 558 for that topic, and any opinion associated with that vote in that topic is used to determine if it is a positive vote or a negative vote. Thus votes 558 for the topic may be implicitly identified from more complex opinion formats such as voice or text submissions.

However, any topics or opinions in the output of function 556 that do not match the published topic tags 522 or 526 are assumed to be alternate views expressed by audience members, and hence can be processed separately as new topic tags 562 (e.g., alternate topics and/or voting options). These may be used to automatically modify the published poll record 538, and may even be fed back to the poll generator function 524 to dynamically add previously missing options, which may be published to audience members via the poll publisher 528 and means 530, 532, 534, and 536 to update the poll. In one embodiment, these alternate topics may be presented to the talk show host, producer and/or other human operator before being published. Furthermore, if multiple users express the same alternate view, this may also be used to generate implicit votes to be provided to a vote counter function 560.

The explicit votes 546 as well as implicit votes 558 are provided to vote counter function 560. This function simply tallies the votes for each option of each topic, and may generate statistical information as well.

The tallied voting results 564 are provided along with any alternate topic tags 562 generated by function 556 to the Feedback Publisher, for publication to audience members as well as the talk show operators. Voting results may be processed by a text formatter function 570 to generate user-friendly text results such as “32% of you voted for Solar Energy, 26% voted for Coal”. Simple comparison with each other, or heuristics may be used to assign more descriptive language, such as “Most of you voted for Solar Energy, where as the least voted for Offshore Drilling”. Similarly, alternate topics 562 may be processed by the text formatter function 570 for conversion into a user-friendly format, such as “Alternative suggestions include: Geothermal Power”. Voting results 564 generated from the explicit votes 546 as well as implicit votes 558 may be processed by a graph generator function 572 to provide a graphical representation of the results, which may be more visually appealing and intuitive for users. The voting results 564 provided to the graph generator function 572 may also include the corresponding topic keywords and related opinion keywords (for example, in a key-value format, a part of the results 564 may look like this: “Topic=Wind Energy; approve=12%; disapprove=25%; neutral=63%”). These may be used to label the graphs appropriately. Graphs may be generated in one or more formats, including bar graphs, line graphs, pie charts and the like.

The generated graphs and text comprise the audience feedback, and are provided to the results publisher 574, which publishes these results to the audience members as well as the talk show host, producer and other operators. Again, feedback results may be published via multiple means 530, 532, 534, and 536.

In one embodiment, the publishing operation is continuous, that is, new results or updates to old results are published continuously as more topic tags are generated, more polls are published, and more opinions are collected. However, this may generate a large amount of network traffic as a large number of audience members may participate in published polls. Hence, in a preferred embodiment, updates are published periodically, where the period between publishing updates is relatively short to simulate a sufficiently real-time updating process, say on the order of a few seconds to a minute. In another embodiment, the period between publishing updates may be adapted dynamically based on one or more of the number of receivers, the number of updates, the amount of information to publish in each update, the distribution means for publishing updates, and network congestion metrics.

Note that at any stage of this entire process, a human operator may be involved, either for filtering, censorship or otherwise monitoring capability. In addition, several of the semantic and ontology analysis techniques involved include a significant margin of error, and can actually provide an error estimate along with their results. In some embodiments, these errors can be monitored by continuously comparing them to pre-configured thresholds, and if they exceed those thresholds, human intervention can be requested. Even then, some errors, and possibly spam submissions, may get through and affect the voting tally, yet at sufficient scale, the noise contributed by these errors may be insignificant compared to the signal of the correctly analyzed results.

Observe that with modern computing capabilities, especially by performing distributed computation over server farms, the process of analyzing speech and identifying and publishing topic tags may be performed within a few seconds, allowing for processing delay and network latencies. Speech-to-text with modern methods is nearly instantaneous, causing only sub-second delays. Semantic analysis, topic extraction and sentiment analysis may incur a delay ranging from milliseconds to a few seconds to a few minutes, depending on the methods used. By selecting relatively fast methods and applying parallel computing, this delay can be kept to a few seconds at the cost of a few errors, which can be removed by strict filtering or manual intervention. Network and broadcast latencies are, again, on the order of milliseconds. Hence the process of generating and publishing a poll from analyzed speech would incur on average a few seconds of delay, and hence, is substantially in real-time.

On the other hand, the process of collecting feedback may be slower, as it is restricted by human response times of the audience members, as well as the fact that some members may choose to think about a poll at length before responding. However, as soon as the user submits a response, the aggregation, calculation and publication of updated voting results can be on the order of milliseconds, and the only practical delay would be the period between publishing updates. Thus, allowing for audience response times, feedback aggregation and publishing is also a near real-time process.

Thus, the entire process from analyzing speech, identifying and publishing topic tags, receiving audience feedback and continuously publishing updated results at short intervals may be performed within a very short duration, which may be on the order of a few seconds up to a few minutes, depending on the rate of audience feedback. Audience feedback can be quickly solicited and collected, and the results continuously updated, and thus a talk show host can consult the results and make informed changes to his monologue or dialogue accordingly. Hence, this invention can operate in substantially near real-time.

### EXAMPLE

### Distributed Feedback of Automatically Identified Topics in Talk Radio

A talk radio show host is talking about President Obama's and Senator McCain's healthcare policies.

The semantic speech analyzer 130 processes the host's speech and identifies “energy”, “oil”, “policy”, “elections”, “Obama” and “McCain” as relevant keywords.

The semantic speech analyzer 130 performs an ontological look-up on these keywords and identifies “Obama's Energy Policy”, “McCain's Energy Policy”, “American Dependence on Oil” and “Election 2008” as interesting identified topics.

Of these, the semantic speech analyzer 130 identifies the first three as topics suitable to vote on, as the ontology includes data that indicates that these are controversial and/or subjective topics. The fourth topic “Election 2008” is deemed to be too broad. A topic may be deemed to be too broad based on metadata included in the ontology, depth of a topic in the ontology, number of child nodes of a topic node on the ontology, a blacklist of topics from show producer, and the like.

The semantic speech analyzer 130 then checks the ontology for other proximal nodes on “Energy Policy” and other topics identified as interesting topics.

The semantic speech analyzer 130 finds an entry for “P. Hilton's Energy Policy”, which is marked as “humorous”.

The semantic speech analyzer's 130 rule-set indicates that some level of entertainment is allowed in the voting process, and hence includes that in the identified topic data.

The semantic speech analyzer 130 then provides these three options to the topic tag publisher 135, which generates and disseminates a poll to the listening audience over multiple channels:
a. One channel is via push to subscribed devices over the Internet,
b. Another channel is via a pull from a networked server by interested devices over the Internet, and
c. Another channel is by embedding the tag data, or a pointer to it, within the talk show content itself using watermarking.

Receiving devices such as communication devices/media players (e.g., 105, 110, 115) extract the topic tags from the appropriate channels and present them to their users.

Audience participants are able to vote (e.g., “Approve”, “Disapprove”, “Neutral” or use the slide bars as shown in the GUI of FIG. 2) or otherwise present opinions (say or type “I think Obama should reconsider wind energy”) on each topic tag on which they have an opinion.

This opinion data, which could be Boolean, text, audio or video, is transmitted to the opinion server 140.

This opinion data can be analyzed by the opinion server 140 depending on a combination of:
a. rules configured for analysis techniques to be applied;
b. rules concerning the identified topics; and/or
c. rules concerning the type of opinion data (i.e., is it voting, text, speech, video, etc.).

Hence, from the opinion data, other options for the published topics (“Wind Energy”) or semantically relevant topics (“Iran”) are identified.

Irrelevant topics and obvious flames (“<Host Name> EXPLETIVE!!!”) are filtered out.

Statistics are collected about these topics (how many seem to approve, disapprove, etc.).

A graph, for example, is generated collating all of this information, and presented to the talk show host as well as the audience participants via the feedback publisher 145.

The talk show host notices “Wind Energy” as a topic he has not considered and brings it up in his talk, thus soliciting more opinions on that topic.

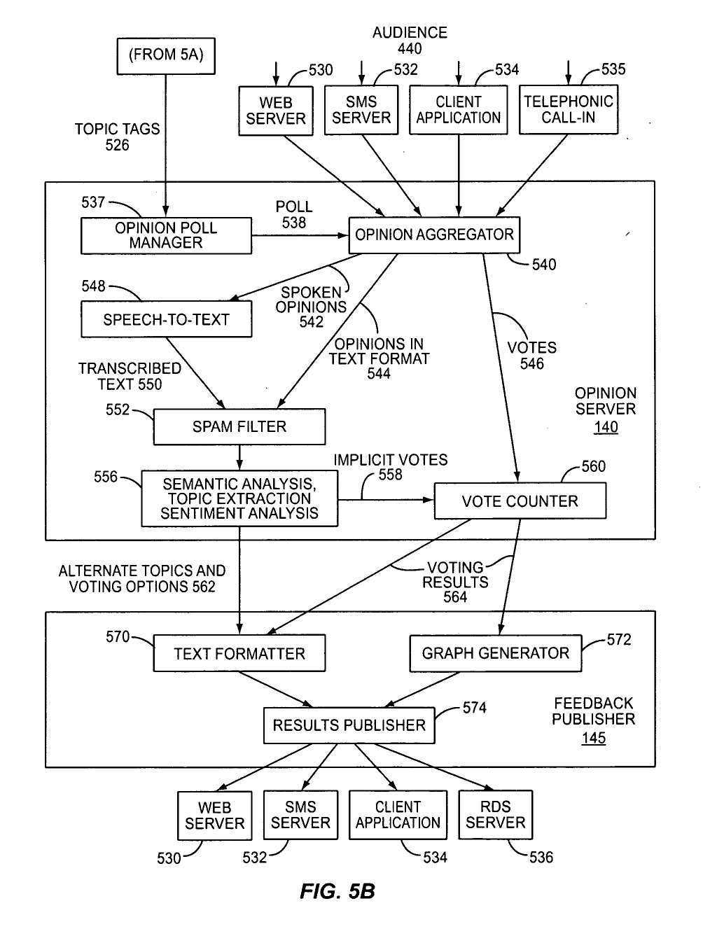

FIG. 6 is a block diagram of a system 600 hosting the distributed feedback service 605, which can include one or more of semantic speech analyzer 130, topic tag publisher 135, opinion server 140, and feedback publisher 145, according to one embodiment of the present invention. In general, the system includes a control system 610 having associated memory 615. In this embodiment, the distributed feedback service 605 is implemented in software and stored in the memory 615. However, the present invention is not limited thereto. The distributed feedback service 605 may be implemented in software, hardware, or a combination thereof. The system 600 also includes one or more digital storage devices 620, at least one communication interface 625 communicatively coupling the system 600 to the one or more user devices 105 through 120, and a user interface 630, which may include components such as, for example, a display, one or more user input devices, or the like. Note that the system is exemplary. The distributed feedback service 605 may be implemented on a single server or distributed over a number of servers.

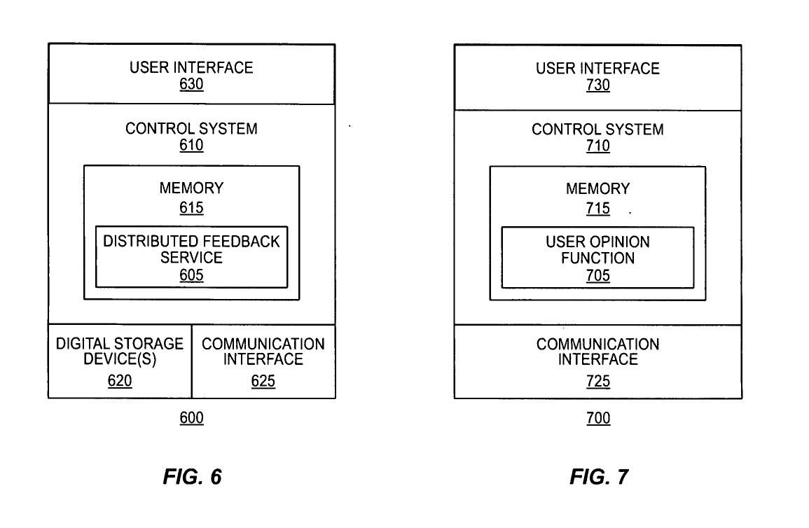

FIG. 7 is a block diagram of a user device 700 such as user device 105 according to one embodiment of the present disclosure. This discussion is equally applicable to the other user devices 110 through 120. In general, user device 700 includes a control system 710 having associated memory 715. In this embodiment, a user opinion function 705 is implemented in software and stored in the memory 715. However, the present invention is not limited thereto. The user opinion function 705 may be implemented in software, hardware, or a combination thereof. The user device 700 also includes a communication interface 725 communicatively coupling the user device 700 to the network. Lastly, the user device 700 includes a user interface 730, which may include a display, one or more user input devices, one or more speakers, and/or the like.

The present invention has substantial opportunity for variation without departing from the spirit or scope of the present invention. For example, while the embodiments discussed herein are directed to talk radio or television program examples, the present invention is not limited thereto. For example, the setting could be a live lecture such as an educational lecture as part of a college course, or a live motivational lecture, or the like. Further, while the examples refer to audio/video content, the present invention is not limited thereto and other forms of media content are contemplated herein.

Those skilled in the art will recognize improvements and modifications to the preferred embodiments of the present invention. All such improvements and modifications are considered within the scope of the concepts disclosed herein and the claims that follow.

What is claimed is:

1. A computer implemented method of distributed audience feedback of media content in one of real time or substantially real time, comprising:
semantically analyzing, at a semantic speech analysis engine, media content from a media program and identifying relevant topic data;
distributing, at a topic data publisher, the identified relevant topic data to an audience of the media program;
collecting, at a server, audience opinions on the identified relevant topic data; and
processing the collected audience opinions.

2. The method of claim 1, wherein the media content comprises at least one of a video content, an audio content, a live talk radio show content, a live television talk show content, a live lecture content, or a live web-cast content.

3. The method of claim 1, wherein the relevant topic data comprises at least one of keywords, tags, metadata describing a topic, an identifier for a specific topic, or voting options.

4. The method of claim 1, wherein the step of semantically analyzing the media content comprises speech-to-text conversion.

5. The method of claim 4, wherein the step of semantically analyzing the media content further comprises at least one of topic extraction or sentiment analysis.

6. The method of claim 1, wherein the step of distributing of the identified relevant topic data comprises at least one of:
broadcasting or multicasting the identified relevant topic data in the same channel as the media content by multiplexing,
broadcasting or multicasting the identified relevant topic data in the same channel as the media content by embedding the identified relevant topic data in the media content using watermarking,
broadcasting or multicasting the identified relevant topic data in a separate channel, or
making available the identified relevant topic data on a network server for audience participants to pull on demand.

7. The method of claim 1, wherein the collecting of audience opinions on the identified relevant topic data comprises:
at least one of presenting the identified topic data to audience participants or generating and presenting semantically relevant options to the audience participants;
receiving the audience participants' opinions on the identified relevant topic data; and
communicating the received audience participants' opinions to the server.

8. The method of claim 1, wherein the processing of the collected audience opinions comprises semantically analyzing audience participants' opinion data, and collecting statistical data on the audience participants' opinion data.

9. The method of claim 1, further comprising presenting, by a feedback publisher, the processed opinion data as feedback results in real time or near real time to at least one of a media show host via a communication device, a producer of the media program via a communication device, or the media program audience participants via their respective communication devices.

10. The method of claim 1, wherein at least one of the distributing of the identified relevant topic data to the media program audience participants via their respective communication devices, or the collecting of audience opinions on identified topics, is carried out under access control, such that topic data and/or feedback participation are only provided to receivers who are verified to be actively consuming the media program.

11. A system for distributed audience feedback of media content, comprising:
means for semantically analyzing media content from a media program and identifying relevant topic data;
means for distributing the identified relevant topic data to an audience of the media program; and
a server which collects audience opinions on the identified relevant topic data, and which processes the collected audience opinions.

12. The system of claim 11, further comprising:
a feedback publisher which presents the processed opinion data as feedback results in real time or near real time to at least one of a media show host via a communication device, a producer of the media program via a communication device, or the media program audience participants via their respective communication devices.

13. The system of claim 11, wherein the media content comprises at least one of a video content, an audio content, a live talk radio show content, a live television talk show content, a live lecture content, or a live web-cast content.

14. The system of claim 11, wherein the relevant topic data comprises at least one of keywords, tags, metadata describing a topic, an identifier for a specific topic, or voting options.

15. The system of claim 11, wherein the means for semantically analyzing the media content comprises speech-to-text conversion.

16. The system of claim 15, wherein the means for semantically analyzing the media content further comprises at least one of topic extraction or sentiment analysis.

17. A non-transitory, computer readable medium comprising a program for instructing a media system to:
semantically analyze media content from a media program and identify relevant topic data;
distribute the identified relevant topic data to an audience of the media program;
collect audience opinions on the identified relevant topic data; and
process the collected audience opinions.

18. The computer readable medium of claim 17, wherein the media content comprises at least one of a video content, an audio content, a live talk radio show content, a live television talk show content, a live lecture content, or a live web-cast content.

19. The computer readable medium of claim 17, wherein the relevant topic data comprises at least one of keywords, tags, metadata describing a topic, an identifier for a specific topic, or voting options.

20. The computer readable medium of claim 17, wherein the semantic analysis of the media content comprises speech-to-text conversion.

21. The computer readable medium of claim 20, wherein the semantic analysis of the media content further comprises at least one of topic extraction or sentiment analysis.

22. The computer readable medium of claim 17, wherein the program further instructs the media system to: present the processed opinion data as feedback results in real time or near real time to at least one of a media show host via a communication device, a producer of the media program via a communication device, or the media program audience participants via their respective communication devices.

23. The computer readable medium of claim 22, wherein the program further instructs the media system to: generate a graph to present the processed opinion data as feedback results to at least one of the media show host, the producer of the media program, or the media program audience participants via their respective communication devices.

24. The computer readable medium of claim 17, wherein the program further instructs the media system to:
present a graphical user interface (GUI) to the media program audience participants in the form of a series of slide bars to permit each audience participant to register their opinion.

25. The computer readable medium of claim 24, wherein opinions follow generic, pre-configured templates.

26. The computer readable medium of claim 17, wherein the step of at least one of distributing of the identified relevant topic data to the media program audience participants via their respective communication devices, or collecting of audience opinions on identified topics, is carried out under access control, such that topic data and/or feedback participation are only provided to receivers who are verified to be actively consuming the media program.

27. A system for distributed audience feedback of media content, comprising:
a semantic speech analysis engine which semantically analyzes media content from a media program and identifies relevant topic data;
a topic data publisher which distributes the identified relevant topic data to an audience of the media program; and
a server which collects audience opinions on the identified relevant topic data, and which processes the collected audience opinions.

28. The system of claim 27, further comprising: a feedback publisher which presents the processed opinion data as feedback results in real time or near real time to at least one of a media show host via a communication device, a producer of the media program via a communication device, or the media program audience participants via their respective communication devices.

29. The system of claim 27, wherein the media content comprises at least one of a video content, an audio content, a live talk radio show content, a live television talk show content, a live lecture content, or a live web-cast content.

30. The system of claim 27, wherein the relevant topic data comprises at least one of keywords, tags, metadata describing a topic, an identifier for a specific topic, or voting options.

31. The system of claim 27, wherein the semantic speech analysis engine which semantically analyzes the media content comprises topic extraction to extract keywords or terms that identify a main topic or topics of speech.
